(19) United States
(12) Patent Application Publication
(10) Pub. No.: US 2026/0166739 A1
(43) Pub. Date: Jun. 18, 2026

(54) TIMEOUT HANDLING AND RECOVERY FOR HARDWARE MODULES OF A REAL-TIME ROBOTICS CONTROL FRAMEWORK

(71) Applicant: Intrinsic Innovation LLC, Mountain View, CA (US)

(72) Inventors: Sebastian Schneider, Feldkirchen (DE); Andre Gaschler, Munich (DE)

(21) Appl. No.: 18/981,001

(22) Filed: Dec. 13, 2024

(51) Int. Cl. B25J 9/16

(52) U.S. Cl. CPC B25J 9/1674

(57) ABSTRACT

Methods, systems, and apparatus, including computer programs encoded on computer storage media, for controlling robots. One method includes receiving custom hardware configuration data for a robot, wherein the custom hardware configuration data specifies a mapping between parts and interfaces belonging to software modules that each correspond to a respective robotic hardware element of the robot, wherein each software module has one or more interfaces that represent capabilities of a robot, and wherein each part, in real-time control code defining actions of a real-time control layer, can reference interfaces of multiple software modules; allocating shared memory resources according to the mapping between parts and interfaces defined in the custom hardware configuration data; executing each software module in a separate process of a real-time control system; and executing the real-time control code that references the interfaces using parts defined in the custom hardware configuration data.

### BACKGROUND

This specification relates to frameworks for robotic control systems.

Real-time software control systems are software systems that must execute within strict timing requirements to achieve normal operation. The timing requirements often specify that certain actions must be executed, or outputs must be generated within a particular time window in order for the system to avoid entering a fault state. In the fault state, the system can halt execution or take some other action that interrupts normal operation. Such real-time software control systems are often used to control physical machines that have high precision and timing requirements. As one example, a workcell of industrial robots can be controlled by a real-time software control system that requires each robot to repeatedly receive commands at a certain frequency, e.g., 1, 10, or 100 kHz. If one of the robots does not receive a command during one of the periodic time windows, the robot can enter a fault state by halting its operation or by automatically executing a recovery procedure to return to a maintenance position.

Real-time robotics control frameworks can provide the capability for driving real-time operation of varied and heterogeneous hardware devices. However, such advanced capabilities can introduce a substantial amount of fragility with respect to hard real-time requirements. For example, a single missed message can cause the entire system to veer into a fault state. This fragility is compounded by the fact that hardware modules that control such hardware devices typically lack any awareness of the presence of or the operational status of other hardware modules.

### SUMMARY

This specification describes a real-time robotics control framework that implements and executes multiple hardware modules for real-time control. Specifically, the real-time robotics framework can monitor for cycle time violations of the hardware modules described in this specification based on executing the multiple hardware modules to control one or more physical robots (e.g., can execute one or more physical robots, including any associated sensors or end effectors, within strict timing requirements to achieve normal operation of the robotic system). Additionally, the hardware modules can monitor for cycle time violations of the real-time robotics framework.

In this specification, a framework is a software system that allows a user to provide higher level program definitions of desired functionality, while the framework takes care of implementing the lower level control functionality of a real-time robotics system. In this specification, the operating environment includes multiple subsystems, each of which can include one or more real-time robots, one or more computing devices having software or hardware modules that support the operation of the robots, or both. The framework provides mechanisms for bridging, communication, or coordination between the multiple systems, including forwarding control parameters from a robot application system, providing sensor measurements to a real-time robotic control system, and receiving hardware control inputs from the real-time robotic control system, all while maintaining the tight timing constraints of the real-time robot control system, i.e., within certain periodic time windows.

In this specification, a workcell is the physical environment in which a robot will operate. Workcells have particular physical properties, e.g., physical dimensions that impose constraints on how robots can move within the workcell.

Particular embodiments of the subject matter described in this specification can be implemented so as to realize one or more of the following advantages.

Existing robotics application frameworks that dictate the interface of hardware modules and devices do not currently have the capability to execute or manage different configurations of hardware modules from different manufacturers in different manners or to allow users, such as developers, to provide custom configuration data for the hardware modules. A real-time control system is a software system that is required to perform actions within strict timing requirements in order to achieve normal operation. As such, the system may occasionally violate the real-time cycle time, and due to the absence of custom configuration data, in particular, custom timing configuration data, the robotics framework may unnecessarily enter a fault state, resulting in increased system latency and decreased flexibility.

In contrast, the real-time robotics control framework disclosed in this specification allows users to specify monitoring behavior of hardware modules for cycle time violations for the hardware modules in order to fit the characteristics of the hardware. Additionally, the system can also use the hardware modules to monitor for cycle time violations of the real-time robotics control framework.

In particular, the system allows users to specify fault tolerance values for each of the hardware modules to cycle time violations. The real-time robotics control framework can then use the configuration data of the hardware modules to monitor for cycle time violations and implement one or more fault recovery steps to handle the cycle time violations and allow for an efficient system recovery. That is, a user can provide custom deactivation functions for each hardware module that specify particular fault recovery actions for the particular hardware module. In some cases, the system can allow cycle time violations based on the fault tolerance values, such that the system can continue executing the hardware module or other associated hardware modules without unnecessarily entering a fault state or performing fault recovery procedures.

The system can also use the hardware modules to monitor for cycle time violations of the real-time robotics control framework and implement the one or more fault recovery steps to allow for an efficient system recovery. That is, for a particular hardware module, the hardware module can determine a cycle time violation based on exchanging communications with the real-time robotics control system, such that the hardware modules can also perform certain fault recovery actions based on the cycle time violation.

Thus, both the real-time robotics control framework, as disclosed in this specification, and the hardware modules can implement custom cycle time monitoring behavior to allow real-time control of the robotic hardware while monitoring for cycle time violations and performing certain actions based on the fault tolerance values for the hardware module and communications between the control framework and the hardware modules. Implementing the custom cycle time monitoring behavior can provide additional capabilities for the robot to react in a more natural and fluid way, which results in higher precision movements, shorter cycle times, and more reliability when completing a particular task. Additionally, by allowing certain cycle time violations, the system is able to efficiently continue executing the hardware modules in order to complete the particular task.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is an example illustration of a real-time hardware abstraction layer executing different hardware modules implemented as part of a real-time robotics control system.

FIG. 3 is a flowchart of an example process for executing the multiple hardware modules implemented as part of the real-time robotics control system.

Like reference numbers and designations in the various drawings indicate like elements.

### DETAILED DESCRIPTION

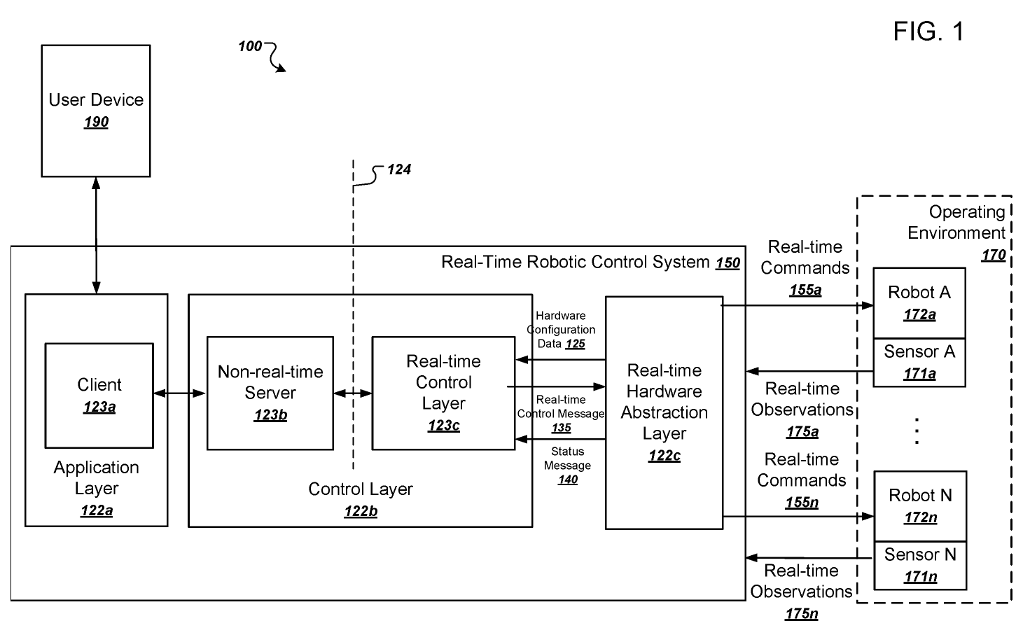

FIG. 1 is a diagram of an example system 100. The system 100 includes a real-time robotic control system 150 to drive multiple robots 172a-n in an operating environment 170. The system 100 includes a number of functional components that can each be implemented as computer programs installed on one or more computers in one or more locations that are coupled to each other through any appropriate communications network, e.g., an intranet or the Internet, or combination of networks.

The system 100 is an example of a system that can implement the real-time robotics control framework as described in this specification. In particular, the system 100 can provide a unified framework that allows users to achieve multiple different types of custom real-time control. In this specification, a robotic control system being described as being real-time means that it is required to execute within strict timing requirements to achieve normal operation. The timing requirements specify that certain actions must be executed, or outputs must be generated within a particular time window in order for the system to avoid entering a fault state. For brevity, each time window may be referred to as a tick or a control tick. In the fault state, after a tick has elapsed without completing its required computations or actions, the system can halt execution or take some other action that interrupts normal operation, e.g., returning the robots to a starting pose or a fault pose.

Operations, e.g., processing steps for completing a task or function, in a non-real-time system are known as non-deterministic operations, which are not required to complete within a given tick to be successful. In contrast, a real-time system requires deterministic operations, which are required to occur every tick. In non-real-time and real-time systems, a scheduler may be utilized to determine the amount of resources, e.g., network bandwidth, memory, processor cycles, or a combination thereof, that an action is allotted for execution. If no or inadequate resources are allocated, the real-time system can also enter the fault state.

In this specification, real-time control being extensible and customizable means that a user can integrate an arbitrary piece of robotic hardware, e.g., a robot of an arbitrary make and/or model, into an operating environment by providing custom real-time control information that specifies how the robot should act or react at each tick of a real-time control cycle. In this specification, an action refers to a motion having precomputed motion parameters, such as moving a tool on a robot arm from point A to point B.

The real-time robotic control system 150 is configured to control the robots 172a-n in the operating environment 170 according to custom real-time control information. To control the robots 170a-n in the operating environment 170, the real-time robotic control system 150 provides commands, e.g., commands 155a-n, to be executed by one or more robots, e.g., robots 172a-n, in the operating environment 170. In order to compute the commands 155, the real-time robotic control system 150 consumes real-time observations 175a-n made by one or more sensors 171a-n gathering data within the operating environment 170. As illustrated in FIG. 1, each sensor 171 is coupled to a respective robot 172. However, the sensors need not have a one-to-one correspondence with robots and need not be coupled to the robots. In fact, each robot can have multiple sensors, and the sensors can be mounted on stationary or movable surfaces in the operating environment 170. Any suitable sensors 171 can be used, such as distance sensors, force sensors, torque sensors, cameras, to name just a few examples.

A powerful feature of the framework provided by the system 100 is that it can allow users to specify fault tolerance values for cycle time violations of hardware modules. That is, the system allows a user to indicate the tolerance of hardware module for cycle time violations during a real-time control cycle. This capability for custom cycle time violation detection allows for the system to refrain from unnecessarily entering a fault state, while efficiently monitoring for violations that require triggering a fault procedure. Additionally, due the customizability of the hardware modules, the system can refrain from attempting to integrate many heterogenous devices, and instead, the hardware modules themselves can dictate their functionality for both real time control of a robot, as well as monitoring for cycle time violations of the framework.

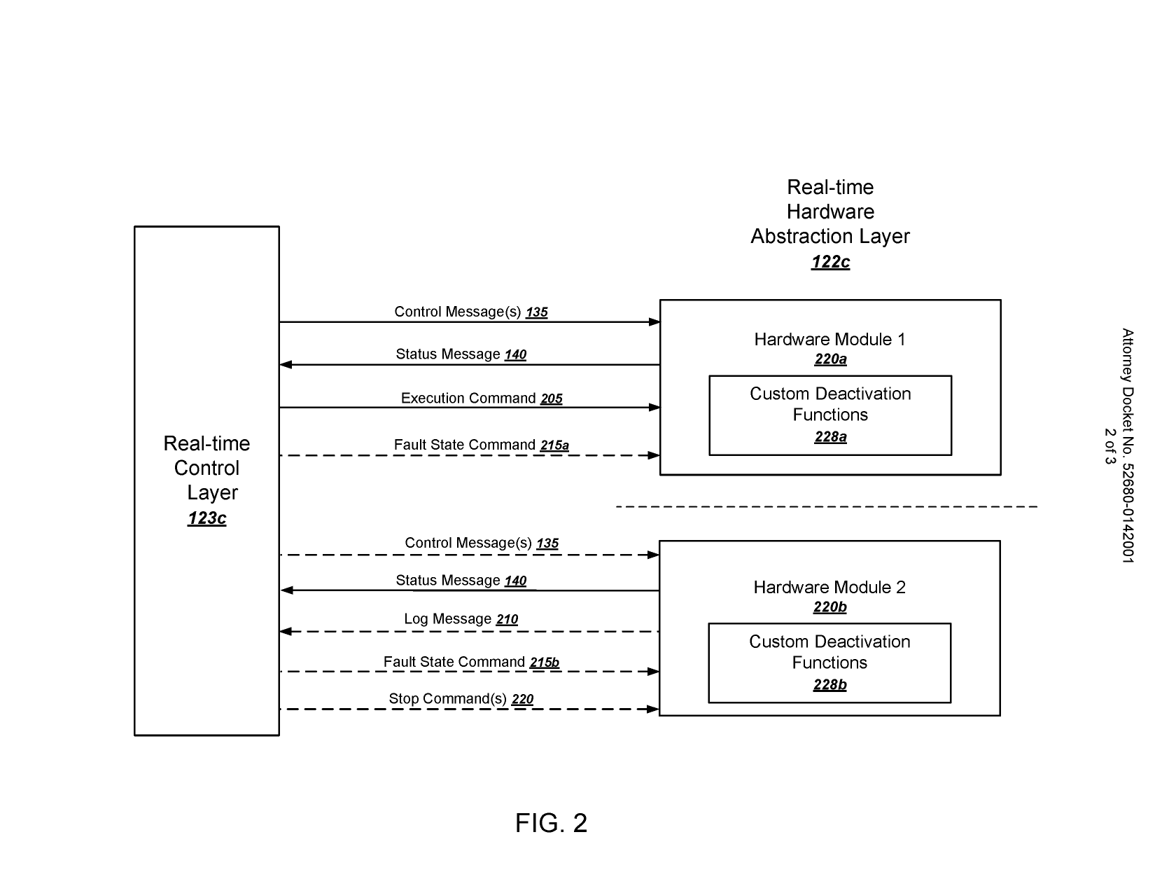

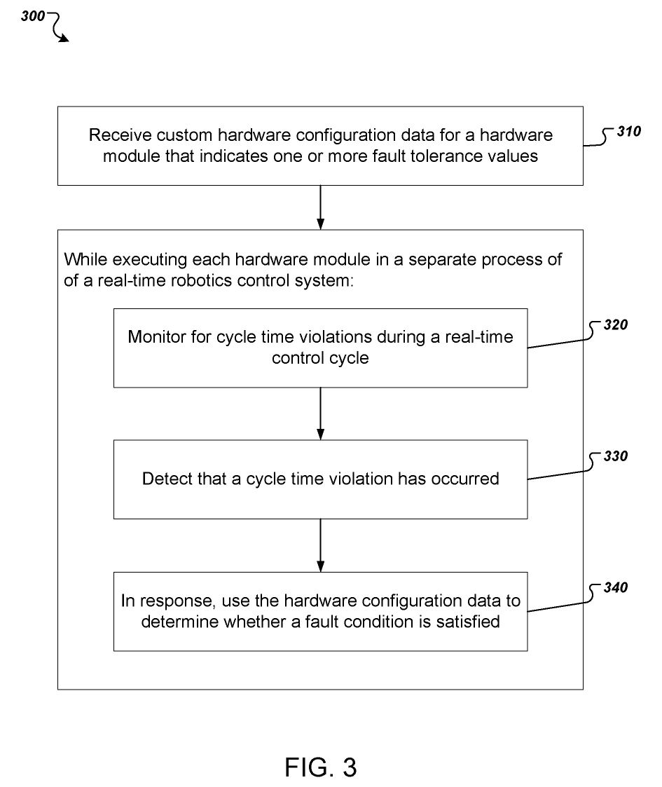

A user of the system 100 can initiate the execution of custom real-time control by providing custom real-time control information to the real-time robotic control system 150. For example, a user can use a user device 190 to provide custom real-time control information to the application layer 122a. For example, through an integrated development environment (IDE) executed in the user device 190, the user can write code and create configuration files that are required to facilitate the real-time control of the one or more hardware modules to monitor for cycle time violations. In some examples, a user of the system, such as a hardware module developer, can provide hardware configuration data 125 for execution of the hardware modules, as described in further detail below with reference to FIGS. 2 and 3.

The system 100 can also provide custom real-time control of other suitable equipment associated with a robot. For example, the user can similarly provide custom real-time control information that specifies how a sensor or tool (or end effector) in the workcell should operate at each tick of a real-time control cycle, either in tandem with or independently of a robot. Example sensors include distance sensors, force sensors, torque sensors, cameras, and the like. Example tools include grippers, welding devices, gluing devices, sanding devices, and the like.

The real-time robotic control system 150 can then prepare the custom real-time control code for execution. Generally, the real-time robotic control system 150 can provide commands through a control stack 122 that handles providing real-time control commands 155a-n to the robots 172a-n. The control stack 122 can be implemented as a software stack that is at least partially hardware-agnostic. In other words, in some implementations the software stack can accept, as input, commands generated by the control system 150 without requiring the commands to relate specifically to a particular model of robot or to a particular robotic component.

The control stack 122 includes multiple levels, with each level having one or more corresponding software modules. In FIG. 1, the lowest level is the real-time hardware abstraction layer 122c which executes within strict real-time requirements, e.g., by providing a command at a first, fixed rate, e.g., every 5, 10, or 20 milliseconds, and the highest level is the application layer 122a which executes within non-real-time requirements, e.g., by providing a command at second, lower rate, which may sometimes be a varying rate or a rate that is sporadic, or both. Interposed between the non-real-time application layer 122a and the real-time hardware abstraction layer 122c is a control layer 122b, which handles bridging the boundary 124 between the non-real-time commands generated by upper-level software modules in the control stack 122 and the real-time commands generated by the lower-level software modules in the control stack 122. More details of the control stack 122 are described in commonly owned U.S. Patent Application No. 17/246,082, which is herein incorporated by reference.

The control layer 122b can include both a real-time control layer 123c and a non-real-time server 123b that collectively facilitate real-time control of the robots in the operating environment 170. The control layer 122b serves as a bridging module in the control stack that translates each non-real-time command into data that can be consumed by real-time controllers that are responsible for generating low-level real-time commands. Such low-level real-time commands can, for example, relate to the actual levels of electrical current to be applied to robot motors and actuators at each point in time in order to effectuate the movements specified by the command.

Upon being provided with the definition of the custom real-time action, the non-real-time server 123b in the control layer 122b can use this definition to initialize all the motion parameters for driving robots in the operating environment 170 and other state variables for real-time execution. For example, the non-real-time server 123b can preallocate memory and perform data format conversions between non-real-time data formats and real-time data formats. In the meantime, the real-time control layer 123c can use this definition to produce continuous real-time control signals including, e.g., real-time positions, velocities, or torques for a robot component such as a robot joint, which determine how to drive the motors and actuators of the robots 172a-n in order to effectuate the custom real-time action. The continuous real-time control signals can then be consumed by the hardware abstraction layer 122c.

The hardware abstraction layer 122c includes hardware modules that actually interface the robot 172a-n, e.g., by issuing real-time commands 155a-n to drive the movements of the moveable components such as joints of the robots 172a-n in the operating environment 170. During execution of each hardware module, the system can monitor for cycle time violations during the real-time control cycle. In the case of detecting a cycle time violation, the system, the hardware module, or both can determine whether a fault condition is satisfied based on one or more fault tolerance values. In some cases, based on determining a fault condition is satisfied, the system can enter a fault state based on one or more respective custom deactivation functions for the one or more of the hardware modules, as described in further detail below with reference to FIGS. 2 and 3.

In this specification, a “hardware module” refers to a separate piece of software, including the means for moving a piece of hardware, that has a specific task or function within the system 100 and is usually programmed or programmable by software or firmware or by a user establishing specific settings to achieve a specific task or function. For example, a hardware module can control a physical robotic hardware element, e.g., a moveable component such as a joint of a robot (including the means for moving the joint, e.g., an actuator or a motor), or can alternatively control a tool or a sensor that is used by the robot, or can further alternatively be a peripheral device in the operating environment 170, e.g., an Ethernet for Control Automation Technology (EtherCAT) enabled device, an Inter-Integrated Circuit (I2C) enabled device, or an Inter-IC Sound (I2S) enabled device.

Each hardware module can monitor for cycle time violations of the framework based on communications with the framework, such as status messages 140, as described in further detail below with reference to FIG. 2. That is, each hardware module can monitor from one or more messages received from the framework during the real-time control cycle, and based on not receiving the one or more messages, the hardware module can execute a fault procedure.

In this specification, a “software module” refers to a separate unit of software programming code that has a specific task or function within the system 100. A software module may handle one step in a process or may handle a series of related steps required for completing a task or function. A software module may execute in a single process or threads, or may alternatively execute across multiple processes or threads. For example, a software module residing at the hardware abstraction layer 122c can include software programming code for controlling a hardware module, e.g., a moveable component such as a joint of a robot, within the operating environment 170 by issuing real-time commands to drive the movements of the hardware module to follow a target trajectory. The software module abstracts the real-time commands for the hardware module by manifesting characteristics and capabilities of the underlying hardware module.

In order to compute the real-time commands 155a-n for the robots 172a-n in the operating environment 170 to execute the custom real-time action, the hardware abstraction layer 122c consumes hardware configuration data 125 provided by the real-time control layer 123c. The hardware configuration data 125 can indicate one or more fault tolerance values of each hardware module for monitoring for cycle time violations. The one or more fault tolerance values represent a tolerance of the hardware module to cycle time violations of the real-time control cycle, as described in further detail below with reference to FIGS. 2 and 3. Additionally, the real-time control layer 123c can provide one or more real-time control messages 135 to the hardware abstraction layer 122c for execution of the hardware modules. The hardware abstraction layer 122c then reports status messages 140 back to the real-time control layer 123c generated as a result of the hardware modules monitoring for cycle-time violations during execution of the hardware modules (e.g., during the real-time control cycle).

The hardware abstraction layer 122c also consumes real-time observations 175a-n made by one or more sensors, e.g., sensors 171a-n, that are making observations within the operating environment 170.

FIG. 2 is an example illustration of a real-time hardware abstraction layer executing different hardware modules implemented as part of a real-time robotics control system.

For simplicity, FIG. 2 shows that two hardware modules 220a-b and 220a-b execute at the real-time hardware abstraction layer 122c, where the hardware modules communicate with the real-time control layer 123c. As described above, the hardware modules 220 operate in real-time and thus require a tight integration and communication with the control system 150 in order to operate within the configured cycle time.

In particular, each distinct hardware module 220 can execute in a separate process of the hardware abstraction layer 122c independently from one another. For example, in the case where hardware module 220b is awaiting completion of the process of hardware module 220a, the system can specify a certain time out or deadline after which the hardware module 220b communicates a message to the system, indicating that hardware module 220a has not completed its separate process within a certain period of time.

In general, the system can execute each hardware module in a separate process, and both the control layer 123c and the hardware modules 220 can monitor for cycle time violations during execution. In particular, during execution, the real-time control layer 123c can exchange communications, such as control messages and status messages, with each hardware module 220

An advantage of the hardware abstraction layer 122c is to implement the various hardware modules 220 that interface with the robots of the operating environment 170, including physical robotic hardware, tools, sensors, and peripheral devices, based on user code and/or configuration files. A first functionality includes using custom information from a hardware developer to perform cycle time monitoring of each of the hardware modules 220. That is, a hardware module developer can provide the fault tolerance values and the custom deactivation functions 228 for each hardware module. A second functionality includes using the hardware modules 220 for cycle time monitoring of the system (e.g., the control layer 123c).

For the first functionality, the control layer 123c can execute each hardware module in a separate process of the control system. While executing, the control layer 123c can monitor for cycle time violations of the real-time control cycle based on the fault tolerance values, and in some cases, the control layer 123c can determine for the system to perform one or more fault procedures, as specified by the custom deactivation functions. In some other cases, the control layer 123c can determine to “tolerate” the cycle time violation and to continue executing the hardware module despite the cycle time violation. These custom monitoring actions for each hardware module make it possible to achieve the extensibility and customizability advantage of the framework provided by the system 100. In some implementations, a user, such as a hardware module developer, can provide the custom hardware configuration data for each hardware module. In this case, the hardware module developer can be a separate entity from an entity operating the control system. The custom hardware configuration data can indicate one or more fault tolerance values that represent a tolerance of the system to cycle time violations of the real-time control cycle.

In particular, the one or more fault tolerance values can include a jitter warn threshold that specifies a length of time after a cycle that will trigger a cycle time violation. For example, the length of time can be twice the expected cycle time. In some implementations, the one or more fault tolerance values can include a threshold associated with an expected cycle time duration, a jitter warn threshold that specifies a length of time after a cycle that will trigger a warning as a log message, and/or a jitter max violations threshold that specifies a maximum number of cycle time violations. That is, based on the one or more fault tolerance values, each hardware module can be configured to tolerate occasional cycle time violations (e.g., a number of cycle time violations that is lower than the jitter max violations threshold). In some examples, the control system 150 may also be configured to tolerate occasional cycle time violations.

In some implementations, the one or more fault tolerance values can further include a jitter critical threshold that specifies a length of time after a cycle that will trigger a fault regardless of the number of cycle time violations. In some implementations, the one or more fault tolerance values can further include a violation cool down period value that specifies a length of time for delaying a reset of the number of cycle time violations.

For the second functionality, the hardware modules 220 can themselves monitor for cycle time violations of the control layer 123c based on communications with the control layer 123c. Each hardware module 220 can monitor for cycle time violations during execution based on exchanging communications with the real-time control layer 123c during the real-time control cycle. In some examples, the system can trigger a fault procedure for the particular hardware module 220 based on the communications. Each hardware module can have one or more custom deactivation functions 228 that specifies a fault procedure be performed by the hardware module.

In particular, during execution, the real-time control layer 123c can exchange control messages and status messages with each hardware module 220. Based on the communications, the hardware modules 220 monitor for cycle time violations of the real-time control cycle and detect that a cycle time violation has occurred, allowing for the hardware modules themselves to trigger a fault state.

As an example, the hardware module 220a can receive a control message 135 from the real-time control layer 123c before the real-time control cycle. The hardware module 220a can then send a status message 140 to the real time control layer 123c indicating that the control message 135 was received prior to the real-time control cycle, and the hardware module 220a can determine that the hardware module 220a can continue executing, as the time of receipt of the status message has not exceeded the jitter maximum threshold. Optionally, according to the first functionality, the control layer 123c can monitor and determine whether the time of receipt of the status message from the hardware module 220a has not exceeded the jitter maximum threshold. In response, the control layer 123c can send an execution command 205 to the hardware module 220a to continue executing, allowing for decreased latency of the system.

In another example, the hardware module 220b can receive the control message 135 from the real-time control layer 123 after the real time control cycle. The hardware module 220b can then send the status message 140 to the real time control layer 123 indicating that the control message 135 was received after the real-time control cycle. As such, according to the first functionality, the control layer 123c can compare the time at which the status message 140 was received with the jitter maximum threshold. Optionally, the control layer 123c can determine whether the time of receipt of the status message has exceeded the jitter maximum threshold. If the time the status message 140 was received does not exceed the jitter maximum threshold, the control layer 123c can transmit a warning message to the hardware module 220a and continue executing the hardware module 220a. If the time the status message 140 was received exceeds the jitter maximum threshold, the control layer 123c can detect a cycle time violation.

For each of the cycle time violations, the control layer 123c can maintain a count of the number of cycle time violations, and based on the number of cycle time violations exceeding a threshold (e.g., a jitter max violations threshold), the control layer 123c can trigger a fault procedure of the hardware module 220b. If the hardware module 220b experiences a fault, the control layer 123c can transmit a fault state command 210b to the hardware module 220b to enter into a fault state. Additionally, the control layer 123c can also transmit a fault statement command 210a to other affected hardware modules (e.g., hardware module 220a).

In particular, the hardware module 220b can enter the fault state in order to stop operation of the robot and corresponding parts associated with the identified fault. That is, the hardware module 220b can call the custom deactivation functions 228b in order to provide one or more stop commands to the robot. In this way, the hardware module developer can define the behavior for a hardware module in case there is a fault, such as engaging brakes of a robotic component. The stop commands can include a communication of stop velocities or accelerations, or setting specific DIOs (e.g., stopping a glue dispenser).

Additionally, in order to perform the one or more stop commands, the hardware module 220b transitions from the fault state to a deactivated state, where any call or communication from the control system 150 to the hardware module 220b can return a status message 140 indicating the fault. In some implementations, the system can output the status message 140 for the user to review. The control layer 123c can then clear the identified fault for the hardware module 220b associated with the one or cycle time violations in order to re-enter an activated state.

In another example, the hardware module 220b may not receive the control message 135, and, according to the second functionality, the hardware module 220b can monitor and send the status message 140 to the real-time control layer 123 indicating that the control message 135 was not received. Based on not receiving the control message 135, the hardware module 220b can detect a cycle time violation of the frame work, and, in some cases, trigger a fault state for the control layer 123c.

Based on detecting the cycle time violation, the hardware module 220 can transmit a log message 210 to the real-time control layer 123c. For example, the hardware module 220b can print and transmit a log message 210 indicating the cycle time violation, a count of the number of cycle time violations, or both. Based on the number of cycle time violations, the system 150 or the hardware module 220b can trigger a fault state procedure. In this case, the hardware module 220b can monitor for a length of time for the control system 150 to transmit a response, and if the time exceeds the threshold, the hardware module 220b can enter a fault state. In some implementations, the hardware module 220a can monitor for a fault from the hardware module 220b, and the hardware module 220a can enter a fault state accordingly.

FIG. 3 is a flowchart of an example process 300 for executing the multiple hardware modules implemented as part of the real-time robotics control system. The process 300 can be implemented by one or more computer programs installed on one or more computers and programmed in accordance with this specification. For example, the process 300 can be performed by the real-time robotic control system 150 shown in FIG. 1. For convenience, the process 300 will be described as being performed by a system of one or more computers.

As described above, the system runs a real-time robotics control framework that is composed of a hardware abstraction layer which executes multiple hardware modules within strict real-time requirements, and a real-time control layer which generates continuous real-time control signals can then be consumed by the hardware abstraction layer. The real-time robotics control system is configured to control multiple hardware modules over a real-time control cycle through respective interfaces.

The hardware abstraction layer includes the hardware modules that interface one or more robots, e.g., by issuing real-time commands to drive the movements of the moveable components such as joints of the robots in an operating environment to execute the custom real-time action. Each hardware module can correspond to a respective robotic hardware element of a robot. Each hardware module can have one or more interfaces that represent capabilities of the robot.

The system receives custom hardware configuration data for each hardware module that indicates one or more fault tolerance values (410). The custom hardware configuration data can be a configuration file that is generated by one or more users, and the one or more fault tolerance values represent the tolerance of the real-time robotics control system to cycle time violations of the real-time control cycle. That is, the one or more fault tolerance values are provided by the user as values that indicate a tolerance of the hardware module in allowing cycle time violations (e.g., a particular number of cycle time violations).

In particular, the fault tolerance values include a jitter warn threshold that specifies a length of time after a cycle that will trigger a fault condition. In some examples, the fault tolerance values can include a threshold associated with an expected cycle time duration, a threshold number of cycle time violations, or both.

Additionally, the custom hardware configuration data can include one or more respective custom deactivation functions for one or more respective hardware modules. Each custom deactivation function specifies a fault procedure to be performed by a respective hardware module.

The one or more users can be one or more hardware module developers that are separate entities from the entity operating the real-time control system. That is, the custom hardware configuration data may be provided by different users belonging to different organizations. For example, a first user can be an equipment manufacturer of the robotic hardware, and a second user may be a third-party hardware module developer who determines and specifies the one or more fault tolerance values for the module.

The system can then use the custom hardware configuration data to execute each hardware module in a separate process of the hardware abstraction layer relative to another hardware module. Specifically, during execution of each hardware module, the hardware module monitors for cycle time violations based on the one or more fault tolerance values, and, accordingly, the hardware module can perform a respective fault procedure based on the custom deactivation functions.

In particular, the system monitors for cycle time violations during a real-time control cycle (320). That is, the control system monitors for cycle time violations of the hardware modules, and each hardware module of the system monitors for one or more messages received from the real-time robotics control system during each real-time control cycle.

In some examples, the hardware module can send a status message to the real-time robotics control system after the real-time control cycle. In this case, the system can compare the time at which the status message was received from the hardware module with a particular fault tolerance value. Specifically, the system can compare the time the status message was received and the jitter warn threshold.

In some other examples, the hardware module can send a status message to the real-time robotics control system before the real-time control cycle. In this case, the system can continue to execute the hardware module.

The system detects that a cycle time violation has occurred (330). For example, a first hardware module can determine that a message was not received from the real-time robotics control system during the real-time control cycle. Based on the system comparing the time the status message was received and the jitter warn threshold, the system determine a cycle time violation has occurred.

In response, the system uses the hardware configuration data to determine whether a fault condition is satisfied (340). That is, the system can compare one or more values with the fault tolerance values to determine that the fault condition is satisfied.

In some examples, the system can maintain a count of the number of cycle time violations, and the system can trigger a fault state based on the count of the number of cycle time violations exceeding a maximum number of cycle time violations. In this case, the hardware module can output a log message indicating the one or more cycle time violations, the count of the number of cycle time violations, or both.

In some implementations, in response to determining that a fault condition is satisfied, the system can provide a notification of the fault condition to one or more other hardware modules.

In some implementations, in response to determining that a fault condition is satisfied, the system can implement one or more fault procedures based on the custom deactivation function for the particular hardware module.

For example, the fault procedure can include halting the operation of a robot and the respective parts associated with the identified fault by providing one or more stop commands to the hardware module. In particular, the system can provide the one or more stop commands by calling the respective one or more custom deactivation functions, and the recovery procedure can include returning to a maintenance position.

In some implementations, the real-time control layer can restart one or more of the hardware modules in a new process. In particular, the system can transition from the fault state to a deactivated state that includes deactivating one or more hardware modules associated with the one or more cycle time violations. The system can then reactivate the one or more hardware modules based on the clearing the identified fault associated with the one or more cycle time violations.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an operating environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

receiving, by a real-time robotics control system that is configured to control a plurality of hardware modules over a real-time control cycle through respective interfaces, custom hardware configuration data for a hardware module of the plurality of hardware modules, wherein the custom hardware configuration data indicates one or more fault tolerance values that represent the tolerance of the real-time robotics control system to cycle time violations of the real-time control cycle;

while executing each hardware module in a separate process of the real-time robotics control system:

monitoring for cycle time violations during the real-time control cycle;

detecting that a cycle time violation has occurred; and

in response, using the hardware configuration data to determine whether a fault condition is satisfied.

Embodiment 2 is the method of embodiment 1, further comprising implementing one or more cycle-time violation procedures based on determining that a fault condition is satisfied.

Embodiment 3 is the method of embodiment 1, wherein the fault tolerance values are specified by one or more hardware module developers.

Embodiment 4 is the method of embodiment 3, wherein the one or more hardware module developers are separate entities from an entity operating the real-time control system.

Embodiment 5 is the method of embodiment 3, further comprising:

providing, by the one or more hardware module developers, one or more respective custom deactivation functions for one or more respective hardware modules, wherein each custom deactivation function specifies a fault procedure to be performed by a respective hardware module.

Embodiment 6 is the method of embodiment 5, wherein the one or more fault tolerance values comprise a jitter maximum threshold that specifies a length of time after a cycle that will trigger a fault condition.

Embodiment 7 is the method of embodiment 1, further comprising:

monitoring, by each hardware module, for one or more messages received from the real-time robotics control system during each real-time control cycle;

determining, by a first hardware module, that a message was not received from the real-time robotics control system during a real-time control cycle; and

in response, executing a fault procedure.

Embodiment 8 is the method of embodiment 6,

receiving, after the cycle, a status message from the hardware module;

comparing the time at which the status message was received and the jitter warn threshold; and

determining a cycle time violation based on the comparison.

Embodiment 9 is the method of embodiment 7, further comprising:

receiving, before the real-time control cycle, a status message from the hardware module; and

continuing to execute the hardware module.

Embodiment 10 is the method of embodiment 6, wherein the one or more fault tolerance values further comprise a threshold associated with an expected cycle time duration, a threshold number of cycle time violations, or both.

Embodiment 11 is the method of embodiment 8, further comprising:

maintaining a count of the number of cycle time violations; and

triggering a fault state based on the count of the number of cycle time violations

exceeding a maximum number of cycle time violations.

Embodiment 12 is the method of embodiment 11, wherein triggering a fault state based on the count of the number of cycle time violations exceeding a maximum number of cycle violations comprises:

outputting, by a particular hardware module, a log message indicating the one or more cycle time violations, the count of the number of cycle time violations, or both.

Embodiment 13 is the method of embodiment 12, further comprising:

providing a notification of the fault condition to one or more other hardware modules. Embodiment 14 is the method of embodiment 13, further comprising:

halting operation of a robot and the respective parts of the real-time robotics control system associated with the identified fault by providing one or more stop commands to the hardware module by calling.

Embodiment 15 is the method of embodiment 12, further comprising:

transitioning from the fault state to a deactivated state, wherein the deactivated state comprises deactivating one or more hardware modules associated with the one or more cycle time violations.

Embodiment 16 is the method of embodiment 15, further comprising:

re-activating the one or more hardware modules based on clearing the identified fault associated with the one or more cycle time violations.

Embodiment 17 is a system comprising: one or more computers and one or more storage devices storing instructions that are operable, when executed by the one or more computers, to perform operations comprising:

receiving, by a real-time robotics control system that is configured to control a plurality of hardware modules over a real-time control cycle through respective interfaces, custom hardware configuration data for a hardware module of the plurality of hardware modules, wherein the custom hardware configuration data indicates one or more fault tolerance values that represent the tolerance of the real-time robotics control system to cycle time violations of the real-time control cycle;

while executing each hardware module in a separate process of the real-time robotics control system:

monitoring for cycle time violations during the real-time control cycle;

detecting that a cycle time violation has occurred; and

in response, using the hardware configuration data to determine whether a fault condition is satisfied.

Embodiment 18 is the system of embodiment 17, further comprising implementing one or more cycle-time violation procedures based on determining that a fault condition is satisfied.

Embodiment 19 is the system of embodiment 17, wherein the fault tolerance values are specified by one or more hardware module developers.

Embodiment 20 is the system of embodiment 19, wherein the one or more hardware module developers are separate entities from an entity operating the real-time control system.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A computer-implemented method comprising:
receiving, by a real-time robotics control system that is configured to control a plurality of hardware modules over a real-time control cycle through respective interfaces, custom hardware configuration data for a hardware module of the plurality of hardware modules, wherein the custom hardware configuration data indicates one or more fault tolerance values that represent the tolerance of the real-time robotics control system to cycle time violations of the real-time control cycle;
while executing each hardware module in a separate process of the real-time robotics control system:
monitoring for cycle time violations during the real-time control cycle;
detecting that a cycle time violation has occurred; and
in response, using the hardware configuration data to determine whether a fault condition is satisfied.

2. The method of claim 1, further comprising implementing one or more cycle-time violation procedures based on determining that a fault condition is satisfied.

3. The method of claim 1, wherein the fault tolerance values are specified by one or more hardware module developers.

4. The method of claim 3, wherein the one or more hardware module developers are separate entities from an entity operating the real-time control system.

5. The method of claim 3, further comprising:
providing, by the one or more hardware module developers, one or more respective custom deactivation functions for one or more respective hardware modules, wherein each custom deactivation function specifies a fault procedure to be performed by a respective hardware module.

6. The method of claim 5, wherein the one or more fault tolerance values comprise a jitter maximum threshold that specifies a length of time after a cycle that will trigger a fault condition.

7. The method of claim 1, further comprising:
monitoring, by each hardware module, for one or more messages received from the real-time robotics control system during each real-time control cycle;
determining, by a first hardware module, that a message was not received from the real-time robotics control system during a real-time control cycle; and
in response, executing a fault procedure.

8. The method of claim 6, further comprising:
receiving, after the cycle, a status message from the hardware module;
comparing the time at which the status message was received and the jitter warn threshold; and
determining a cycle time violation based on the comparison.

9. The method of claim 7, further comprising:
receiving, before the real-time control cycle, a status message from the hardware module; and
continuing to execute the hardware module.

10. The method of claim 6, wherein the one or more fault tolerance values further comprise a threshold associated with an expected cycle time duration, a threshold number of cycle time violations, or both.

11. The method of claim 8, further comprising:
maintaining a count of the number of cycle time violations; and
triggering a fault state based on the count of the number of cycle time violations exceeding a maximum number of cycle time violations.

12. The method of claim 11, wherein triggering a fault state based on the count of the number of cycle time violations exceeding a maximum number of cycle violations comprises:
outputting, by a particular hardware module, a log message indicating the one or more cycle time violations, the count of the number of cycle time violations, or both.

13. The method of claim 12, further comprising:
providing a notification of the fault condition to one or more other hardware modules.

14. The method of claim 13, further comprising:
halting operation of a robot and the respective parts of the real-time robotics control system associated with the identified fault by providing one or more stop commands to the hardware module by calling.

15. The method of claim 12, further comprising:
transitioning from the fault state to a deactivated state, wherein the deactivated state comprises deactivating one or more hardware modules associated with the one or more cycle time violations.

16. The method of claim 15, further comprising:
re-activating the one or more hardware modules based on clearing the identified fault associated with the one or more cycle time violations.

17. A system comprising one or more computers and one or more storage devices storing instructions that are operable, when executed by the one or more computers, to cause the one or more computers to perform operations comprising:
receiving, by a real-time robotics control system that is configured to control a plurality of hardware modules over a real-time control cycle through respective interfaces, custom hardware configuration data for a hardware module of the plurality of hardware modules, wherein the custom hardware configuration data indicates one or more fault tolerance values that represent the tolerance of the real-time robotics control system to cycle time violations of the real-time control cycle;
while executing each hardware module in a separate process of the real-time robotics control system:
monitoring for cycle time violations during the real-time control cycle;
detecting that a cycle time violation has occurred; and
in response, using the hardware configuration data to determine whether a fault condition is satisfied.

18. The system of claim 17, further comprising implementing one or more cycle-time violation procedures based on determining that a fault condition is satisfied.

19. The system of claim 17, wherein the fault tolerance values are specified by one or more hardware module developers.

20. The system of claim 19, wherein the one or more hardware module developers are separate entities from an entity operating the real-time control system.
